(19) United States
(12) Patent Application Publication
(10) Pub. No.: US 2015/0373703 A1
(43) Pub. Date: Dec. 24, 2015

(54) Method of Aligning Frame Transmission to Deterministic Time and Related Wireless Device

(71) Applicant: MEDIATEK INC., Hsin-Chu (TW)

(72) Inventor: Shih-Chang Su, Hsinchu County (TW)

(21) Appl. No.: 14/742,719

(22) Filed: Jun. 18, 2015

Related U.S. Application Data
(60) Provisional application No. 62/013,561, filed on Jun. 18, 2014.

(51) Int. Cl. H04W 72/04; H04W 72/12; H04W 28/26; H04W 74/00

(52) U.S. Cl. CPC H04W 72/0446; H04W 74/004; H04W 72/12; H04W 28/26

(57) ABSTRACT

A method for a wireless device in a wireless communication system includes defining a time window prior to a first target time; and transmitting a packet to reserve a channel of the wireless communication system till a second target time when determining that the channel is clear during the time window.

### CROSS REFERENCE TO RELATED APPLICATIONS

This application claims the benefit of U.S. Provisional Application No. 62/013,561 filed on 2014 Jun. 18, the contents of which are incorporated herein in their entirety.

### BACKGROUND

The present invention relates to a method for a wireless communication system and related wireless device, and more particularly, to a method of aligning a frame transmission time to a deterministic time and related wireless device.

Wireless communication has been an important and essential data transmission technique in recent years since it takes several advantages such as high transmission flexibility, high transmission convenience, and high transmission quality. Nowadays, several wireless communications modules for transmitting various radio signals are integrated into a portable electronic device. For example, a Bluetooth (BT) module, a Wireless Local Area Network (WLAN) module, and a long-term-evolution (LTE) module are integrated in an electronic device such as a smartphone or a tablet. To improve the transmission efficiency, two transmission types are applied to achieve the coexistence of multi-radios transmission. The first transmission type is frequency division duplex (FDD) and the second transmission type is time division duplex (TDD). The key idea of the transmission using FDD is to partition a wireless frequency spectrum into several frequency bands and further allocate each radio signal to the corresponding frequency band. On the other hand, the key idea of the transmission using TDD is to determine several time slots during a transmission time interval and then allocate each radio signal to the corresponding time slot. Both FDD and TDD can provide multi-radios coexistence transmission.

IEEE 802.11 wireless local area network (WLAN) specifications define a power save mode for allowing a communication device (e.g. a station) associated to a wireless device, such as an access point (AP) in a wireless communication system, to enter a sleep mode when the communication device does not perform communications. The communication device in the power save mode is required to periodically wake up for receiving Beacon frames and/or traffic indication map (TIM) broadcast frames from the wireless device, to synchronize with the wireless device. If the channel of the wireless communication system is occupied by other communication devices at the time of the wireless device transmitting the Beacon frame and/or the TIM broadcast frames, the wireless device is required to defer the time of transmitting the Beacon frame and/or the TIM broadcast frame till the channel is clear.

For example, please refer to FIG. 1, which is a timing diagram of a typical wireless communication system. As shown in FIG. 1, the wireless device originally plans to transmit the Beacon frame at a time T1, with a time interval as a Time to Beacon target time (TBTT), and transmit the TIM broadcast frame after the Beacon frame. At the time T1, a communication device COM1, such as a station associated with the wireless device, wakes up for a period and expects to receive the Beacon frame and/or the TIM broadcast frame. However, a communication device COM2 transmits a frame at the time T1 and the wireless device is forced to defer the time T1 to a time T1′, resulting that the communication device COM1 keeps waking up till receiving the Beacon frame and/or the TIM broadcast frame. In other words, the communication device COM1 wakes up for an extra time to receive the Beacon frame and/or the TIM broadcast frame. The power consumption of the communication device is therefore increased. Thus, how to minimize the time of the communication device in the power save mode waking up for receiving the Beacon frame and/or the TIM broadcast frame becomes a topic to be discussed.

### SUMMARY

In order to solve the above problem, the present invention provides a method of aligning a frame transmission time to a deterministic time and related communication device.

As an aspect, the present invention discloses a method for a wireless device in a wireless communication system. The method comprises defining, by the wireless device, a time window prior to a first target time; and transmitting, by the wireless device, a packet to reserve a channel of the wireless communication system till a second target time when determining that the channel is clear during the time window.

As to another aspect, the present invention discloses a wireless device in a wireless communication system. The wireless device comprises a computing unit; and a storage unit, for storing a program code used for instructing the computing unit to perform the following steps: defining, by the wireless device, a time window prior to a first target time; and transmitting, by the wireless device a packet to reserve a channel of the wireless communication system till a second target time when determining that the channel is clear during the time window.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a timing diagram of a typical wireless communication system.

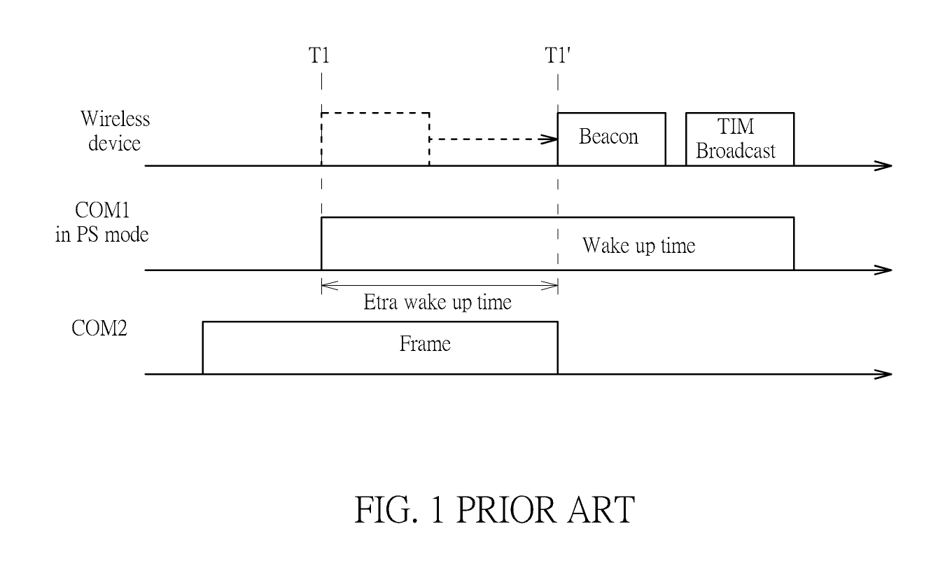

FIG. 2 is a schematic diagram of a wireless communication system according to an example of the present invention.

FIG. 3 is a schematic diagram of a communication device according to an example of the present invention.

FIG. 4 is a flowchart of a process according to an example of the present invention.

FIG. 5 is a timing diagram of the wireless communication system shown in FIG. 2.

FIG. 6 is another timing diagram of the wireless communication system shown in FIG. 2.

FIG. 7 is still another timing diagram of the wireless communication system shown in FIG. 2.

### DETAILED DESCRIPTION

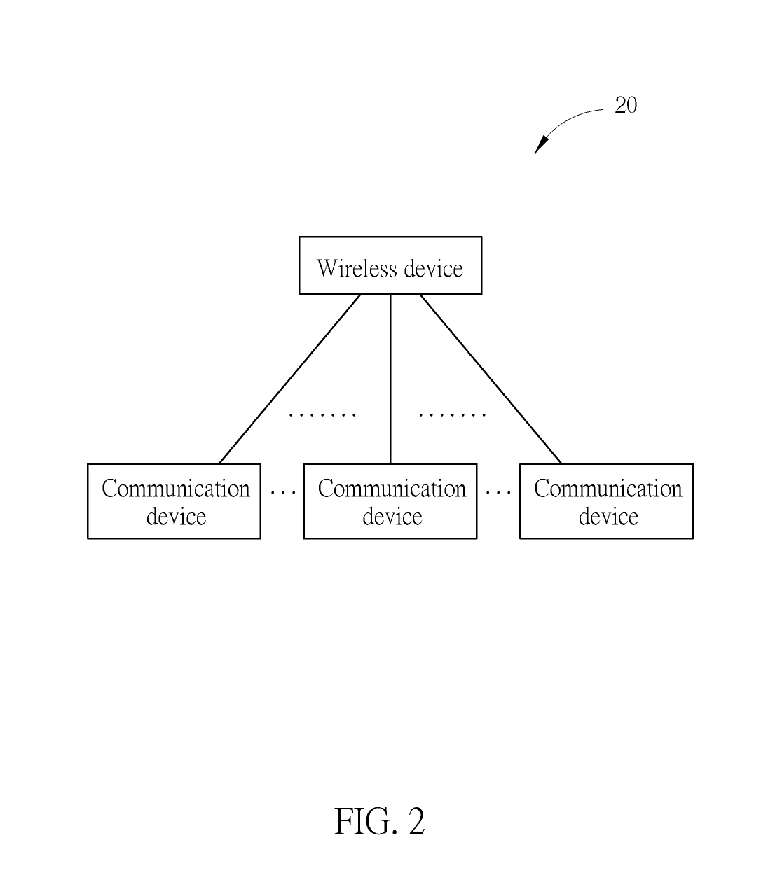

Please refer to FIG. 2, which is a schematic diagram of a wireless communication system 20 according to an example of the present disclosure. The wireless communication system 20 is briefly composed of a wireless device, such as an AP, and a plurality of communication devices. In FIG. 2, the wireless device and the communication devices are simply utilized for illustrating the structure of the wireless communication system 20. Practically, the wireless device may be an access point (AP), or a station operating under access point mode, or any communication device that can transmit a beacon in a wireless local area network (WLAN) system.

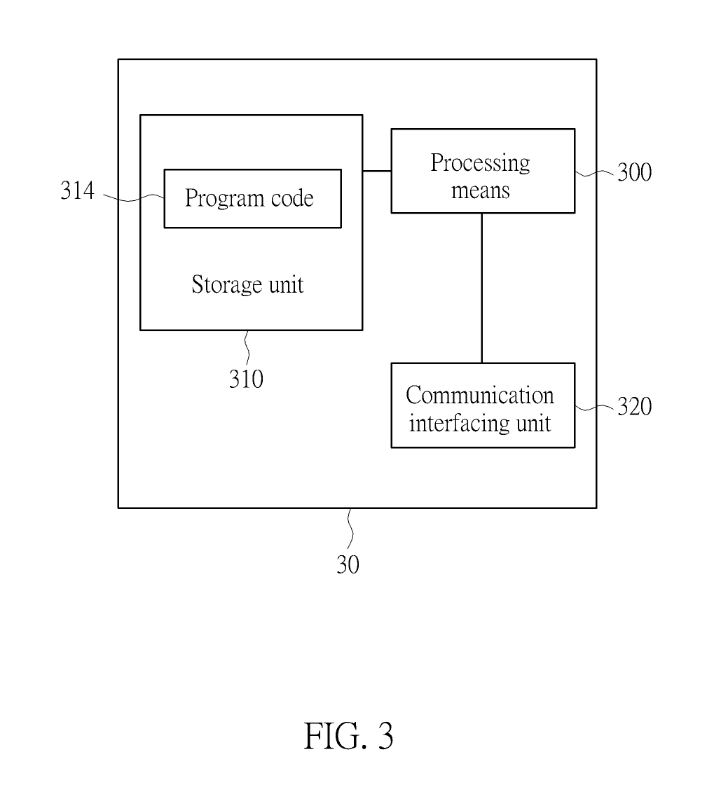

Please refer to FIG. 3, which is a schematic diagram of a communication device 30 according to an example of the present disclosure. The communication device 30 maybe a communication device or the wireless device shown in FIG. 2, but is not limited herein. The communication device 30 may include a processing means 300 such as a microprocessor or Application Specific Integrated Circuit (ASIC), a storage unit 310 and a communication interfacing unit 320. The storage unit 310 may be any data storage device that stores a program code 314, accessed and executed by the processing means 200. Examples of the storage unit 310 include but are not limited to a read-only memory (ROM), flash memory, random-access memory (RAM), CD-ROM/DVD-ROM, magnetic tape, hard disk and optical data storage device. The communication interfacing unit 320 is preferably a transceiver and is used to transmit and receive signals (e.g., messages or frames) according to processing results of the processing means 300.

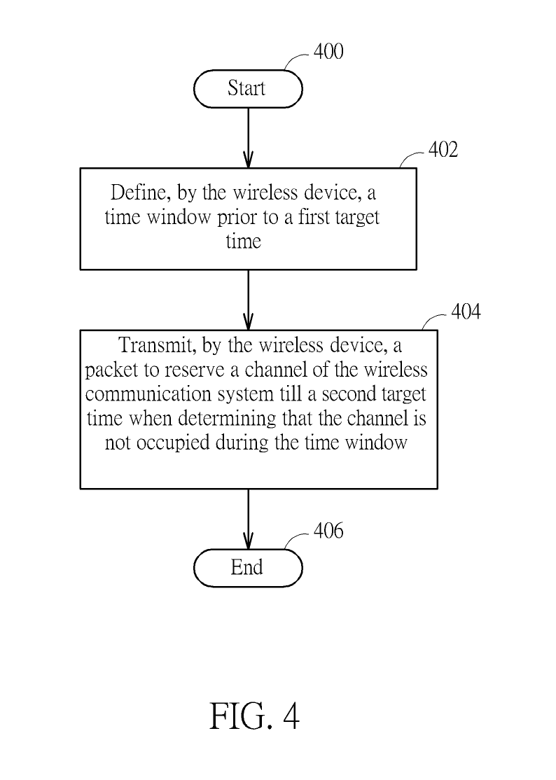

Please refer to FIG. 4, which is a flowchart of a process 40 according to an example of the present invention. The process 40 is utilized in a wireless device (e.g. the AP of the wireless communication system 20 shown in FIG. 2) for aligning a frame transmission (e.g. the Beacon frame and/or traffic indication map (TIM) broadcast frame transmission) to a deterministic time. The process 40 can be compiled into the program code 314 and comprises the following steps:

Step 400: Start.

Step 402: Define, by the wireless device, a time window prior to a first target time.

Step 404: Transmit, by the wireless device, a packet to reserve a channel of the wireless communication system till a second target time when determining that the channel is not occupied during the time window.

Step 406: End.

According to the process 40, the wireless device (e.g. the AP) of the wireless communication system 20 periodically transmits a first frame (e.g. the Beacon frame or the TIM broadcast frame) to the communication devices associated to the wireless device of the wireless communication system 20 at a first target time (e.g. a time to Beacon Target Time (TBTT)). Even if the communication device is in a power save mode, the communication device is required to wake up at the first target time for receiving the first frame. Prior to transmitting the first frame at the first target time, the wireless device defines a time window prior to the first target time and determines whether a channel of the wireless communication system 20 is occupied during the time window. For example, the wireless device may perform Clear Channel Assessment (CCA) to determine whether the channel is occupied, and is not limited herein. When determining that the channel is clear (i.e. not occupied) during the time window, the wireless device transmits a packet (e.g. a Clear to Send to self (CTS2Self) packet) to reserve the channel till a second target time via a Network Allocation Vector (NAV) with timing information for reserving the channel till the second target time. In an example, the first target time is equal to the second target time and the wireless device transmits the first frame (e.g. the Beacon frame or the TIM broadcast frame) at the second target time. In another example, the second target time is after the first target time, the wireless device transmits the first frame (e.g. the Beacon frame) at the first target time and transmits a second frame (e.g. the TIM broadcast frame) at the second target time. In such a condition, the transmission of the first frame and/or the second frame is aligned to the deterministic time. The time of the communication device in the power save mode waking up for receiving the frame is minimized and the communication device in the power save mode would not consume extra power consumption, therefore.

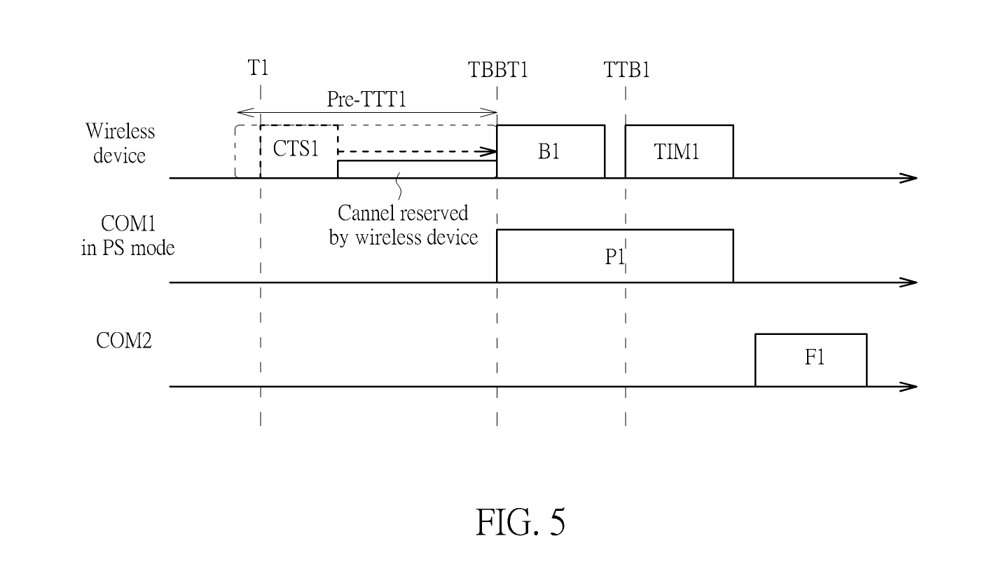

Please refer to FIG. 5, which is a timing diagram according to an example of the present invention. As shown in FIG. 5, the wireless device of the wireless communication system 20 plans to transmit a Beacon frame B1 at a target time TBTT1 and to transmit a following TIM broadcast frame TIM1 at a target time TTB1. In addition, a communication device COM1 in the power save (PS) mode would wake up at the target time TBTT1 for receiving the Beacon frame B1 and the TIM broadcast frame TIM1. Prior to the target time TBTT1, the wireless device defines a time window Pre-TTT1 and checks whether the channel of the wireless communication system 20 is occupied during the time window Pre-TTT1. In this example, once the channel is clear during the time window Pre-TTT1 and the wireless device transmits a CTS2Self packet CTS1 at a time T1 during the time window Pre-TTT1 to reserve the channel till the target time TBTT1. In such a condition, the Beacon frame B1 is guaranteed to be transmitted at the time TBTT1. That is, the transmission of the Beacon frame B1 is aligned to the target time TBTT1. The communication device COM1 in the power save mode wakes up for a period P1 and immediately returns to the power save mode after receiving the TIM broadcast frame TIM1. In addition, a communication device COM2 can transmit a frame F1 after the TIM broadcast frame TIM1. As can be seen from the above, the time of the communication device COM1 in the power save mode waking up (i.e. the period P1 shown in FIG. 5) is minimized and the communication device would not consume extra power consumption, therefore.

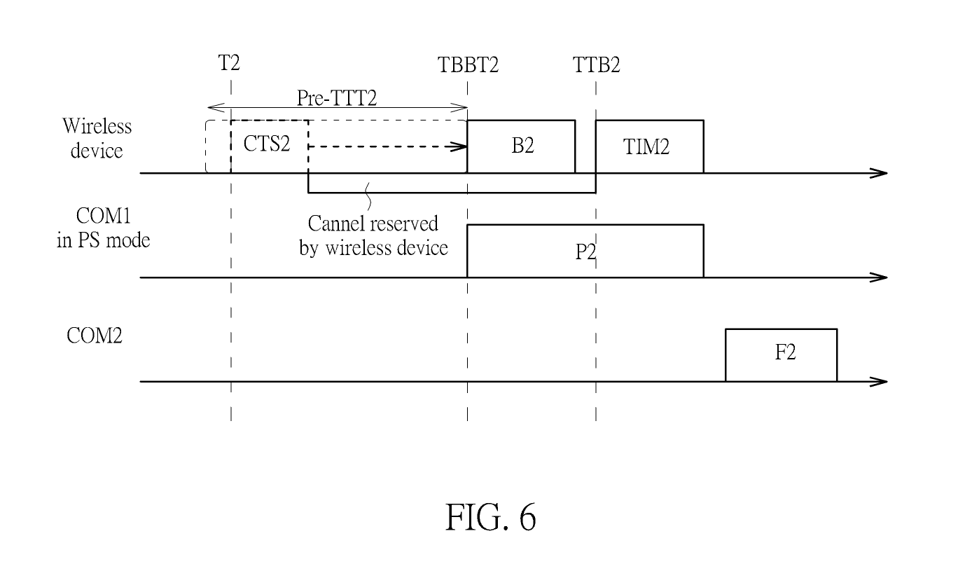

In FIG. 5, the target time TTB1 of transmitting the TIM broadcast frame TIM1 may be deferred if other communication devices (e.g. the communication device COM2) in the wireless communication system 20 reserve the channel prior to the target time TTB1. In order to prevent the target time TTB1 of transmitting the TIM broadcast frame TIM1 being postponed and the communication device COM1 in the power save mode needed to wake up for an additional time, the wireless device may reserve the channel till the target time TTB1. Please refer to FIG. 6, which is a timing diagram according to an example of the present invention. Similar to FIG. 5, the wireless device of the wireless communication system 20 expects to transmit a Beacon frame B2 at a target time TBTT2 and to transmit a following TIM broadcast frame TIM2 at a target time TTB2. In this example, the wireless device also defines a time window Pre-TTT2 prior to the target time TBTT2 of transmitting the Beacon frame B2 and determines whether the channel of the wireless communication system 20 is occupied during the time window Pre-TTT2. Once the channel is clear during the time window Pre-TTT2, the wireless device transmits a CTS2Self packet CTS2 at a time T2, to reserve the channel till the target time TTB2 of transmitting the TIM broadcast frame TIM2. Under such a condition, the Beacon frame B2 and the TIM broadcast frame TIM2 are guaranteed to be transmitted at the target times TBTT2 and TTB2, respectively. In other words, the transmissions of the Beacon frame B2 and the TIM broadcast frame TIM2 are respectively aligned to the target times TBTT2 and TTB2. The communication device COM1 in power save mode may return to the power save mode after receiving the TIM broadcast frame TIM2. The time of the communication device COM1 in the power save mode waking up (i.e. the period P2 shown in FIG. 6) is minimized and the power consumption of the communication device COM1 is decreased, therefore.

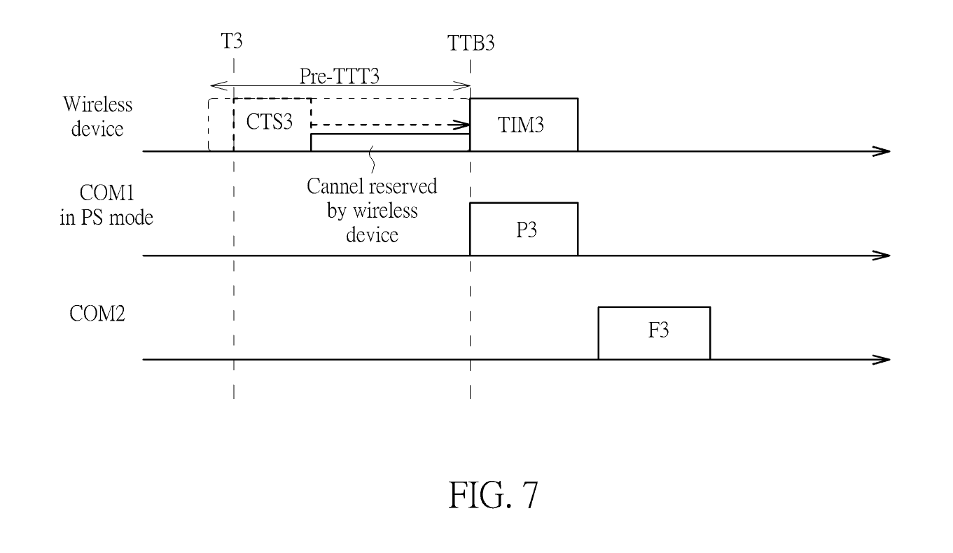

Please refer to FIG. 7, which is a timing diagram according to an example of the present invention. In this example, the wireless device expects to transmit a TIM broadcast frame TIM3 at a target time TTB3 and the communication device COM in the power save mode would wake up at the target time TTB3 for receiving the TIM broadcast frame TIM3. According to the process 40, the wireless device defines a time window Pre-TTT3 prior to the target time TTB3 and determines whether the channel of the wireless communication system 20 is occupied during the time window Pre-TTT3. Once the channel is clear during the time window Pre-TTT3, the wireless device transmits a CTS2Self packet CTS3 to reserve the channel till the target time TTB3. The TIM broadcast frame TIM3 therefore can be guaranteed to be transmitted at the target time TTB3 and the communication device COM1 in power save mode may return to the power save mode after receiving the TIM broadcast frame TIM3. The time of the communication device COM1 in the power save mode waking up (i.e. the period P3 shown in FIG. 7) is minimized and the power consumption of the communication device COM1 is decreased, therefore.

According to different applications and design concepts, those with ordinary skill in the art may observe appropriate alternations and modifications. In an example, the packet used for reserving the channel maybe a null packet comprising a physical layer convergence procedure (PLCP) length field. In other words, the wireless device reserves the channel via the PLCP. In this example, the null packet may be a Complementary Code Keying (CCK) Quality of Service (QoS) null packet which does not comprise acknowledgment (ACK) and comprises the PCLP length field with timing information for reserving the channel.

Those skilled in the art should readily make combinations, modifications and/or alterations on the abovementioned description and examples. The abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 30.

To sum up, the above example reserves the channel till the target time of transmitting the Beacon frame and/or the TIM broadcast frame during the time window prior to the target time. The time of the communication device in the power save mode waking up is minimized and the power consumption of the communication device in the power save mode is decreased, therefore.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a wireless device in a wireless communication system, the method comprising:
defining, by the wireless device, a time window prior to a first target time; and
transmitting, by the wireless device, a packet to reserve a channel of the wireless communication system till a second target time when determining that the channel is clear during the time window.

2. The method of claim 1, further comprising:
transmitting, by the wireless device, a Beacon frame at the second target time, wherein the second target time is the first target time.

3. The method of claim 1, further comprising:
transmitting, by the wireless device, a Beacon frame at the first target time; and
transmitting, by the wireless device, a traffic indication map (TIM) broadcast frame at the second target time, wherein the second target time is after the first target time.

4. The method of claim 1, further comprising:
transmitting, by the wireless device, a traffic indication map (TIM) broadcast frame at the second target time, wherein the second target time is the first target time.

5. The method of claim 1, wherein the packet is a Clear to Send to self (CTS2Self) packet for triggering a Network Allocation Vector (NAV) with timing information of reserving the channel till the second target time.

6. The method of claim 1, wherein the packet comprises a physical layer convergence procedure (PLCP) length filed with timing information of reserving the channel till the second target time.

7. A wireless device in a wireless communication system, the communication device comprising:
a computing unit; and
a storage unit, for storing a program code used for instructing the computing unit to perform the following steps:
defining, by the wireless device, a time window prior to a first target time; and
transmitting, by the wireless device, a packet to reserve a channel of the wireless communication system till a second target time when determining that the channel is clear during the time window.

8. The wireless device of claim 7, wherein the program code further instructs the computing unit to perform the following steps:
transmitting, by the wireless device, a Beacon frame at the second target time, wherein the second target time is the first target time.

9. The wireless device of claim 7, wherein the program code further instructs the computing unit to perform the following steps:
transmitting, by the wireless device a Beacon frame at the first target time; and
transmitting, by the wireless device, a traffic indication map (TIM) broadcast frame at the second target time, wherein the second target time is after the first target time.

10. The wireless device of claim 7, wherein the program code further instructs the computing unit to perform the following steps:
transmitting a traffic indication map (TIM) broadcast frame at the second target time, wherein the second target time is the first target time.

11. The wireless device of claim 7, wherein the packet is a Clear to Send to self (CTS2Self) packet for triggering a Net Allocation Vector (NAV) with timing information of reserving the channel till the second target time.

12. The wireless device of claim 7, wherein the packet comprises a physical layer convergence procedure (PLCP) length filed with timing information of reserving the channel till the second target time.
